(19) United States
(12) Patent Application Publication
(10) Pub. No.: US 2012/0145303 A1
(43) Pub. Date: Jun. 14, 2012

(54) CAST DECORATION KIT & METHODS OF USE THEREOF

(76) Inventor: Jacqueline G. McClarnan, Alta Loma, CA (US)

(21) Appl. No.: 12/967,081

(22) Filed: Dec. 14, 2010

(51) Int. Cl. B32B 37/12; B44C 1/00

(52) U.S. Cl. 156/60

(57) ABSTRACT

Embodiments of the invention are directed to kits and methods for decorating a cast. In one embodiment, a kit may include instructions, adhesive, an adhesive applicator, a tray and at least one colored wrapping tissue paper with one or more decorative patterns thereon.

### FIELD OF INVENTION

Cast decoration kit.

### BACKGROUND OF INVENTION

An orthopedic cast is a shell, frequently made from plaster, encasing a limb or other body parts to hold a broken bone(s) in place until healing is realized. Plaster bandages consist of a cotton bandage that has been impregnated with Plaster of Paris, which hardens after it has been made wet. Plaster of Paris is calcined Gypsum which is ground to a fine powder by milling. When water is added, the more soluble form of calcium sulfate returns to the relatively insoluble form, and heat is produced. The setting of unmodified plaster starts about ten (10) minutes after mixing and is complete in about 45 minutes; the cast is not fully dry though for seventy-two (72) hours.

More recently, fiberglass bandages are used for orthopedic casts. These consist of a knitted fiberglass bandage impregnated with polyurethane. These are lighter and dry much faster than plaster bandages. However, plaster can be more easily molded to make a snug and therefore more comfortable fit. In addition, plaster is much smoother and does not snag clothing or abrade the skin.

In some cultures, decorating a cast by pre-selecting pre-colored fiberglass bandages or offering the cast as a “template” for autographs and/or writings is common. However, customization is limited by these methods because they only allow pre-selection of a pre-colored fiberglass bandage and/or the writings/autographs are applied at the whim of the writer/autographer.

### SUMMARY OF INVENTION

A cast decorating kit, including: (i) at least one adhesive; (ii) at least one adhesive applicator; (iii) a tray; and (iv) at least one sheet of tissue paper with one or more decorative patterns thereon is herein disclosed. The adhesive may be natural or synthetic. The tissue paper may be from 0.25 grams per cubic centimeter to 0.50 grams per cubic centimeter in density. The adhesive applicator may be one of a brush or an applicator bottle.

A method of customizing a cast, including: (i) applying an adhesive to an outer surface of the cast; (ii) applying at least one sheet of tissue paper with one or more decorative patterns thereon to an outer surface of a cast; (iii) applying an adhesive over the at least one sheet of tissue paper; and (iv) allowing the adhesive to air dry is herein disclosed. The applying and the allowing may be repeated until the outer surface of the cast is substantially covered with the tissue paper. The applying the adhesive may consist of: (a) pouring the adhesive into a tray; (b) dipping a brush into the tray; and (c) brushing the adhesive onto the at least one sheet of tissue paper. The method may further include applying additional decorations with the adhesive and an applicator to the outer surface of the cast. The cast may be one of a human cast or an animal cast. The adhesive may be natural or synthetic.

### BRIEF DESCRIPTION OF DRAWINGS

FIG. 1 illustrates an arm cast of the prior art.

FIG. 2 illustrates a cast decorating kit according to an embodiment of the invention.

FIG. 3A illustrates a front view of a cast decorating kit according to an alternative embodiment of the invention.

FIG. 3B illustrates a back view of the cast decorating kit of FIG. 3A.

FIG. 4 illustrates a cast decorated with the cast decorating kit of FIG. 2 or FIG. 3A-3B according to a method of the invention.

### DETAILED DESCRIPTION

The following detailed description is of the best currently contemplated modes of carrying out the invention. The description is not to be taken in a limiting sense, but is made merely for the purpose of illustrating the general principles of the invention.

Embodiments of the invention are directed to kits and methods for decorating a cast. In one embodiment, a kit may include instructions, adhesive, an adhesive applicator, a tray and at least one colored wrapping tissue paper with one or more decorative patterns thereon.

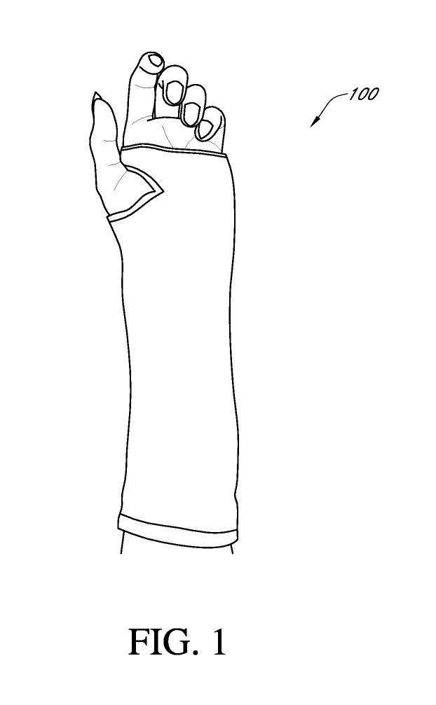

FIG. 1 is a perspective view of a conventional arm cast. As shown, arm cast 100 includes a plurality of bandages wrapped about a person's arm (partially shown). Fiberglass casting tape is wrapped about the plurality of bandages. The method of the wrapping of the bandages and/or fiberglass casting tape is known by one of ordinary skill in the art, such as medical professionals.

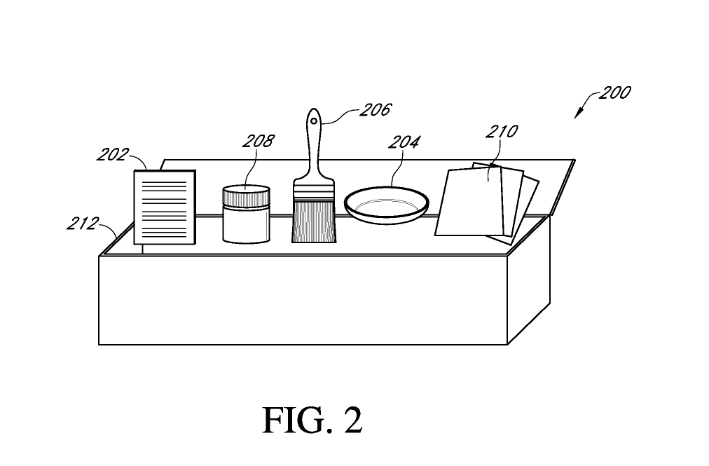

FIG. 2 illustrates a perspective view of a kit for decorating a cast according to an embodiment of the invention. Kit 200 may include, but is not limited to, instructions 202, a plastic tray 204, an adhesive applicator 206, adhesive 208 and at least one sheet of tissue paper 210 with one or more decorative patterns thereon all contained within a reclosable container 212. An “adhesive” or “glue” is a compound in a liquid or semi-liquid state that adheres or bonds items together. Adhesives may come from either natural or synthetic sources. Adhesive 208 may be one of a natural adhesive, synthetic adhesive, drying adhesive, contact adhesive, hot adhesive, ultraviolet- and light-curing adhesive or pressure-sensitive adhesive such as those known by one of ordinary skill in the art. In one embodiment, adhesive 208 is satin, semi-gloss or gloss varnish. In any embodiment, adhesive 208 should be one that will not compromise the integrity of a cast and/or severely irritate the skin of the person in the event that adhesive 208 makes contact with the skin when applied to the cast. Adhesive applicator 206 may include any means to apply adhesive 208. For example, adhesive applicator 206 may be, but is not limited to, a brush, an applicator bottle or any other suitable means. In one embodiment, adhesive 208 is varnish specially formulated for decoupage and papercrafts and known to one of ordinary skill in the art. Tissue paper 210 is a very thin grade paper, typically from about 0.25 grams/cubic centimeter to about 0.50 grams/cubic centimeter in density, and is known to one of ordinary skill in the art. Tissue paper 210 may be any type of design and/or color.

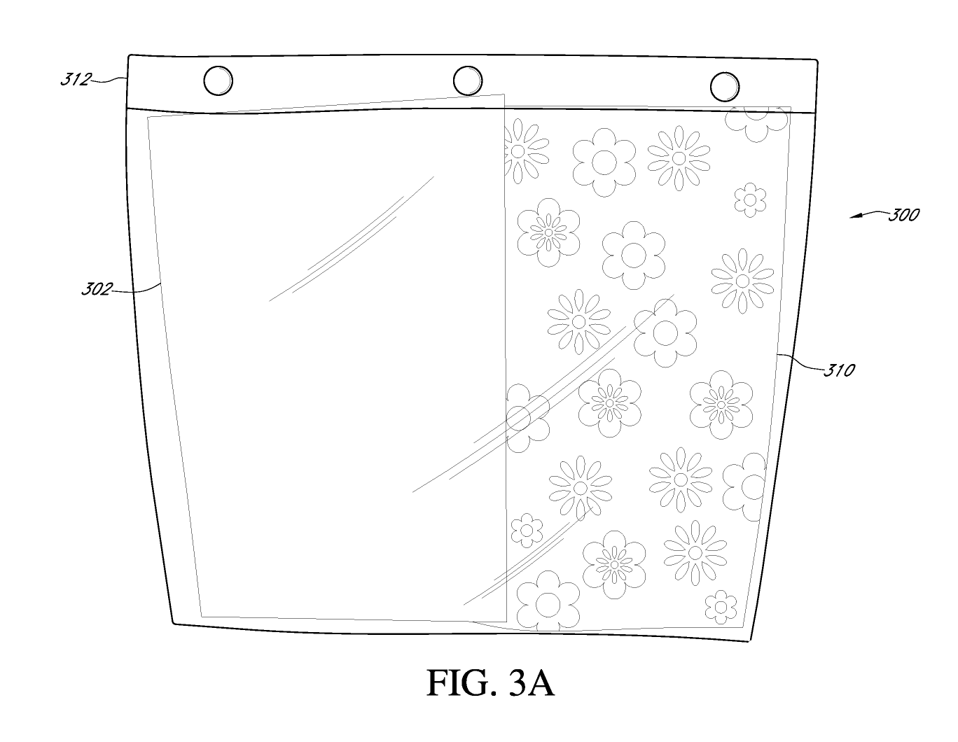

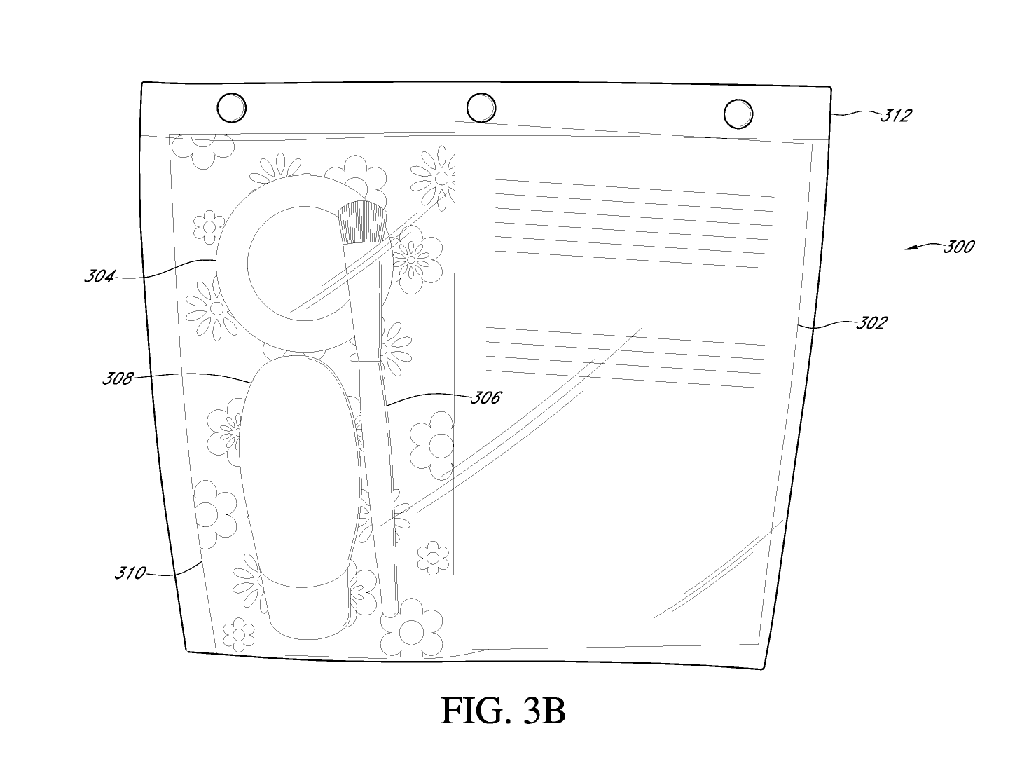

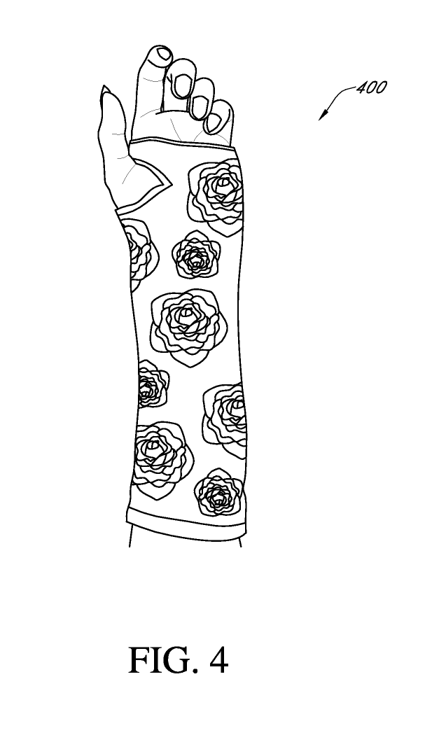

FIG. 3A illustrates a front view of a cast decorating kit according to an alternative embodiment of the invention. Similar to the cast decorating kit illustrated in FIG. 2, kit 300 may include, but is not limited to, instructions 302, a plastic tray 304, an adhesive applicator 306, adhesive 308 and at least one sheet of tissue paper 310 with one or more decorative patterns thereon all contained within a reclosable container 312. In this embodiment, reclosable container 312 is a clear clamshell plastic pouch. FIG. 3B illustrates a back view of the cast decorating kit of FIG. 3A. FIG. 4 illustrates a cast decorated with the cast decorating kit of FIG. 2 or FIG. 3A-3B.

According to embodiments of the invention as described previously, a cast decorating kit may be used to decorate, customize and personalize a cast. In one method, tissue paper 210 or 310 may be positioned on an outer surface of a cast to get a desired visual on how the cast wearer will want the cast to look. Next, light coat of adhesive 208 or 308 may be applied to the cast. Next, tissue paper 210 or 310 may be positioned on an outer surface of a cast. Next, a heavy coat of adhesive 208 or 308 may be applied over tissue paper 210 or 310 to permanently adhere tissue paper 210 or 310 to the cast. These steps may be repeated until the cast is partially, substantially or fully decorated and/or customized. Adhesive 208 or 308 may be applied to the cast by brushing adhesive applicator 206 or 306 into tray 204 or 304. Applying satin, semi-gloss or gloss adhesive 208 or 308 with brush 206 or 306 directly onto tissue paper 210 or 310 (strategically placed on top of a rigid cast) bonds tissue paper 210 or 310 to the rigid cast forming a semi-permanent, weatherproof and washable customized cast surface. Tissue paper 210 or 310 dries hard and clear with little to no yellowing thereof. Repeat application of varnish 208 or 308 may be done without negative effects to the newly decorated cast surface, e.g., smearing or compromising the integrity of the cast itself. As a result, the method according to embodiments of the invention may be used to transform the outer shell of a rigid cast into a semi-permanent, weatherproof and washable customized cast surface.

Advantageously, embodiments of the invention allow a cast-wearer to customize, personalize and beautify a cast. Many cast-wearers view the wearing of a cast as unsightly. Therefore, a cast decorating kit which allows the wearer to customize, personalize and beautify his/her cast may mitigate the unsightliness of the cast itself. Furthermore, a cast decorating kit according to embodiments of the invention may assist in making the cast water-impermeable. This feature may help mitigate and/or partially or substantially prevent the growth of bacteria from flourishing on the surface of the cast when the cast is exposed to water or humidity. Additionally, a cast decorating kit according to embodiments of the invention is user-friendly, easy to apply and cost-effective relative to other methods or practices in the prior art. Additionally, a cast decorating kit according to embodiments of the invention may be applied to a human cast or an animal cast. Additionally, the rigid cast is not comprised in any way, but is rather improved in at least the following ways: (i) in appearance in that it is personalized and customized; (ii) becomes a washable surface, e.g., the cast is washable with soap and water, eliminating dirt and germs without saturation thereof; (iii) becomes weatherproof in that the cast surface becomes substantially or completely impervious to moisture. More particularly, methods according to embodiments of the invention affect only an outside surface of a rigid cast and do not have an affect on or within the interior of rigid cast.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

What is claimed is:

1. A method of customizing a cast, comprising:
applying an adhesive to an outer surface of the cast;
applying at least one sheet of tissue paper with one or more decorative patterns thereon to an outer surface of a cast;
applying the adhesive over the at least one sheet of tissue paper; and
allowing the adhesive to air dry.

2. The method of claim 1 wherein the applying and the allowing is repeated until the outer surface of the cast is substantially covered with the tissue paper.

3. The method of claim 1 wherein the applying the adhesive consists of:
pouring the adhesive into a tray;
dipping a brush into the tray; and
brushing the adhesive onto the at least one sheet of tissue paper.

4. The method of claim 1, further comprising:
applying additional decorations with the adhesive and an applicator to the outer surface of the cast.

5. The method of claim 1 wherein the cast is one of a human cast or an animal cast.

6. The method of claim 1 wherein the adhesive is natural or synthetic.
